(19) United States
(12) Patent Application Publication
(10) Pub. No.: US 2016/0326998 A1
(43) Pub. Date: Nov. 10, 2016

(54) APPARATUS FOR A CHARGING SYSTEM OF AN INTERNAL COMBUSTION ENGINE

(71) Applicants: BorgWarner Inc., Auburn Hills, MI (US); Mann + Hummel GmbH, Ludwigsburg (DE)

(72) Inventors: Dietmar METZ, Meckenheim (DE); Stefan JACOB, Lachen-Speyerdorf (DE); Hedwig SCHICK, Tamm (DE); Herbert PIETROWSKI, Pleidelsheim (DE); Helmut NEUSCHWANDER, Ludwigsburg (DE)

(21) Appl. No.: 15/145,860

(22) Filed: May 4, 2016

(30) Foreign Application Priority Data
May 6, 2015 (DE) 102015208417.5

(51) Int. Cl. F02M 35/10; F02B 37/10; F02B 33/36

(52) U.S. Cl. CPC F02M 35/10275; F02B 33/36; F02B 37/10; F02M 35/10019; F02M 35/10157

(57) ABSTRACT

The invention relates to apparatus (1) for a charging system of an internal combustion engine (31), comprising a housing (2) in which a secondary line (6) of an additional compressor (33) opens at an opening (54) into an air duct (5) of the internal combustion engine (31), a closing device (8) in the housing (2) for closing the air duct (5) upstream of the outlet (54), wherein the closing device (8) is arranged pivotably about a geometric axis of rotation (14), and at least one spring (21) arranged in the housing (2), wherein the spring (21) biases the closing device (8) in the closing direction, and wherein the closing device (8) is moved exclusively by the spring force of the spring (21) and the pressure condition upstream (55) and downstream (56) of the closing device (8).

### CROSS-REFERENCE TO RELATED APPLICATIONS

This application claims the benefit of German Patent Application No. 102015208417.5 filed May 6, 2015, the disclosure of which is herein incorporated by reference in its entirety.

### DESCRIPTION

The invention relates to an apparatus for a charging system of an internal combustion engine. In particular, a closing device in the air duct leading to the internal combustion engine is described.

The use of one or multiple compressors for charging internal combustion engines, in particular, in motor vehicles, is known from the prior art. The compressors may thereby be electrically driven or driven as a component of exhaust gas turbochargers. Depending on the arrangement of the different compressors, valves are thereby needed in the intake system. Publication DE 102 45 336 A1 shows previously known designs of a closing device.

The object of the present invention is to provide an apparatus for a charging system of an internal combustion engine which consistently functions in low maintenance operation and is inexpensive to manufacture. In particular, the closing device of the apparatus is to open and close with low friction and seal well.

The solution to this problem is carried out by the features of the independent claims. The dependent claims have advantageous embodiments of the invention as their subject matter.

The problem is thus solved by an apparatus for a charging system of an internal combustion engine. The apparatus comprises a housing. In the housing, a secondary line of an additional compressor opens into an air duct leading to the internal combustion engine. The secondary line leads from the additional compressor into the air duct. Within the context of the invention, the air duct leads from the air filter up to the intake manifold. In particular, the section prior to the intake manifold is also designated as an “intake pipe”. As will be described in detail, a preferred main compressor is located in the air duct. The section of the air duct upstream of the main compressor is designated as the intake line. The section of the air duct downstream of the main compressor is designated as the main charge air line. The secondary line opens into either the main charge air line or into the intake line.

The apparatus further comprises a self-regulating closing device, in particular, designed as a flap. The closing device is arranged in the housing and functions for closing the air duct, thus the main charge air duct or the intake line, upstream of the opening. The closing device is arranged inside of the housing in such a way that it is pivotable around an axis of rotation. “Axis of rotation” is understood within the scope of the invention as the geometric axis of rotation. The actual component for the embodiment of the axis of rotation is described in the scope of an advantageous embodiment as a “shaft”.

The apparatus further comprises a spring arranged in the housing. The spring is designed to bias the closing device in the closed direction. The spring ensures that the closing device contacts the sealing seat as long as no pressure conditions are present which open the closing device. As soon as the pressure in the secondary line is correspondingly higher than in the air duct, the closing device is pressed into the sealing seat and the aid duct is closed. The spring thus ensures that the closing device is always at the correct point, specifically at the sealing seat, in the unpressurized state, and the spring additionally prevents a constant rattling of the closing device, as a defined position is predetermined by the spring.

This is, according to the invention, a self-regulating closing device, as the closing device is exclusively moved by the spring and the pressure conditions. The closing device, including the rotatably moveable elements accommodating the closing device and the spring, are encapsulated in the housing. No elements extend thereby out of the housing to the exterior. This has the advantage that no seals are necessary. At the same time, a compact structure encapsulated in the housing thus results. No active control unit is provided within or outside of the housing to move the closing device.

It is preferably provided that the spring is designed as a coiled torsion spring. This torsion spring is thus spiral shaped. The axis of the torsion spring coincides with the axis of rotation of the closing device. The torsion spring is, in particular, made from wire. An inexpensive structure is guaranteed by such a torsion spring. At the same time, the torsion spring ensures a maintenance free and durable function of the closing device.

The torsion spring particularly preferably has a spiral shape and functions simultaneously as a compression spring in the axial direction. This may be achieved, for example, in that the individual coils of the torsion spring do not contact one another but instead are spaced apart from one another. Thus, the torsion spring has preferably two functions: according to the first function, the torsion spring biases the closing device in the rotational direction. According to the second function, the torsion spring biases the closing device in the axial direction. Due to the axial biasing, play in the axial direction is prevented in the closing device and an axial stop is always guaranteed.

A particularly low-friction bearing is designed on at least one axial stop of the shaft. In particular, this is the lower axial stop of the shaft. On this axial stop, either (i) a sphere is arranged, or (ii) a pin is formed on the housing or on the shaft, or (iii) a point is formed on the housing or on the shaft. The sphere, pin, or point ensures in this case a centering of the shaft and simultaneously a very low bearing surface with respect to the housing. Thus, a very low friction torque is achieved in the axial stop of the shaft.

As already described, the torsion spring advantageously also functions as a compression spring. This compression spring presses the closing device including the shaft into the axial low-friction stop with the sphere, the pin, or the point.

Furthermore, a first bearing component is preferably provided for rotatably moveable support of the shaft. The first bearing component is located advantageously at the low-friction stop, thus advantageously on the bottom side of the shaft. A plain bearing is advantageously formed between the shaft and the first bearing component.

The first bearing component is preferably fixed in the housing via an elastic element. This elastic element is, in particular, an O-ring encircling the axis of rotation.

The elastic receiving of the lower bearing component ensures a bearing clearance roundness with respect to the roundness of the bearing seat in the housing. At the same time, the elastic element ensures a damping of the shaft. Furthermore, the shaft may shift due to the flexible elastic element, which enables a better contact of the closing device on the sealing seat. A higher level of sealing results therefrom.

In addition, a second bearing component is preferably provided for rotatable support of the shaft. In particular, the second bearing component is located on the upper end of the shaft. The torsion spring is arranged, in particular, on the shaft between the second bearing component and the closing device. The second bearing component is advantageously pushed into the housing in a positive locking way. This enables a simple and inexpensive assembly, as the compete unit made of the closing device, shaft, torsion spring, and bearing components may be pushed into the housing.

The torsion spring advantageously has two shanks. The one shank is supported directly on the second bearing component. A hole is advantageously provided in the second bearing component for this purpose. The shank sticks into this hole.

The diametrically opposite shank of the torsion spring is supported advantageously on the closing device.

It is preferably provided that the closing device has a plate and a fastening region. The plate and the fastening region may be one piece or may be manufactured as two different components. The fastening region is connected rotatably fixed to the shaft. In particular, the fastening region is a relatively thin sheet metal, preferably in the range from 0.2 to 1 mm.

The fastening region is preferably bent at an angle α to the plate. The angle α lies advantageously between 10 and 45°, particularly preferably between 20 and 40°. The bent section and the flexible articulation resulting therefrom improve the contact of the closing device on the sealing seat.

It is further preferably provided that a seal is arranged on the closing device, in particular, on the plate. The seal is formed, in particular, completely encircling the periphery of the closing device. Advantageously, the seal is manufactured by overmoulding the plate with an elastomer. It is particularly preferable that silicone rubber (VMQ), fluorosilicone rubber (FVMQ), and/or low-temperature fluorocarbon is used as the sealing material. It is thereby taken into consideration that these materials guarantee a sufficient flexibility, and thus a good seal, not only at high temperatures but also at very low temperatures. For example, when using the closing device upstream of an exhaust gas turbocharger, the temperatures are relatively low and the sufficient flexibility of the sealing material has to be guaranteed here as well.

The additional compressor preferably has an electric motor for driving the additional compressor wheel. It is thereby particularly provided that the low-pressure side of the additional compressor branches off upstream of the closing device. The pressure side of the additional compressor opens out into the air duct downstream of the closing device. It is thus a bypass closing device of the additional compressor.

A main compressor is additionally preferably provided. The main compressor is, in particular, a component of the exhaust gas turbocharger. The main compressor wheel of the main compressor is arranged either upstream or downstream of the closing device and compresses the air in the air duct.

It is preferably provided that at least one acoustic damper is arranged in the secondary line upstream of the supplemental compressor, and/or at least one acoustic damper is arranged in the secondary line downstream of the additional compressor, and/or at least one acoustic damper is arranged in the air duct upstream of the main compressor, and/or at least one acoustic damper is arranged in the air duct downstream of the main compressor.

Additional details, features, and advantages of the invention arise from the subsequent description of an embodiment with reference to the drawings:

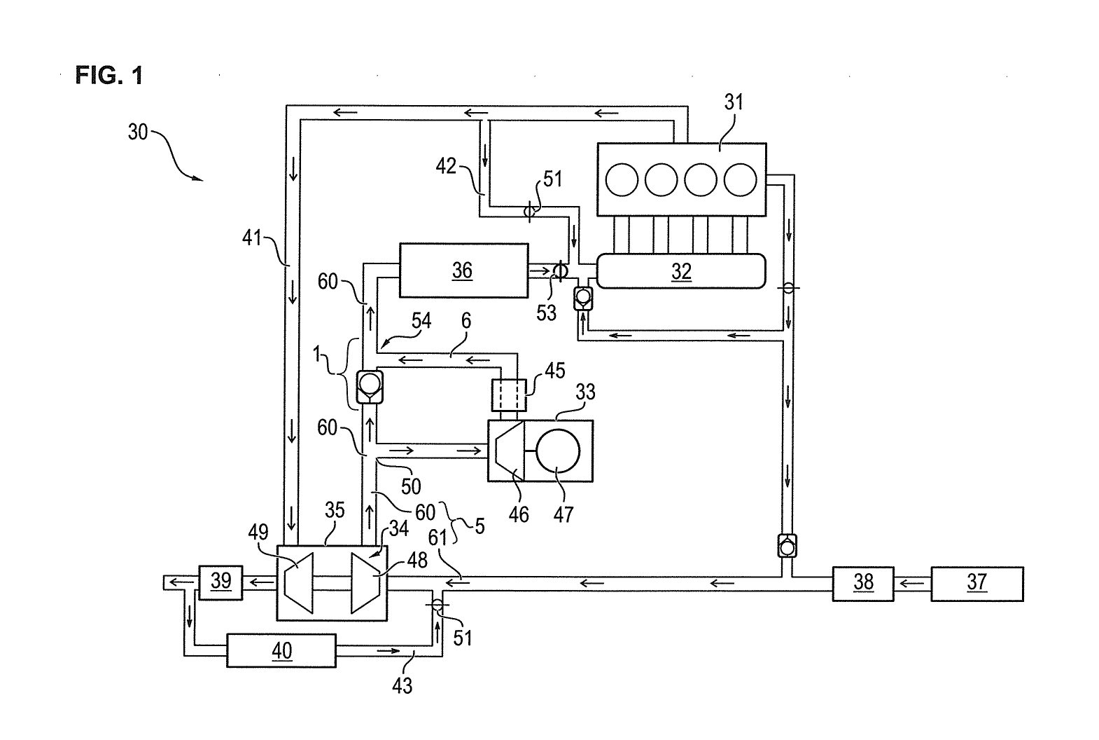

FIG. 1 shows a schematic first arrangement of the apparatus according to the invention according to the embodiment in connection to an internal combustion engine,

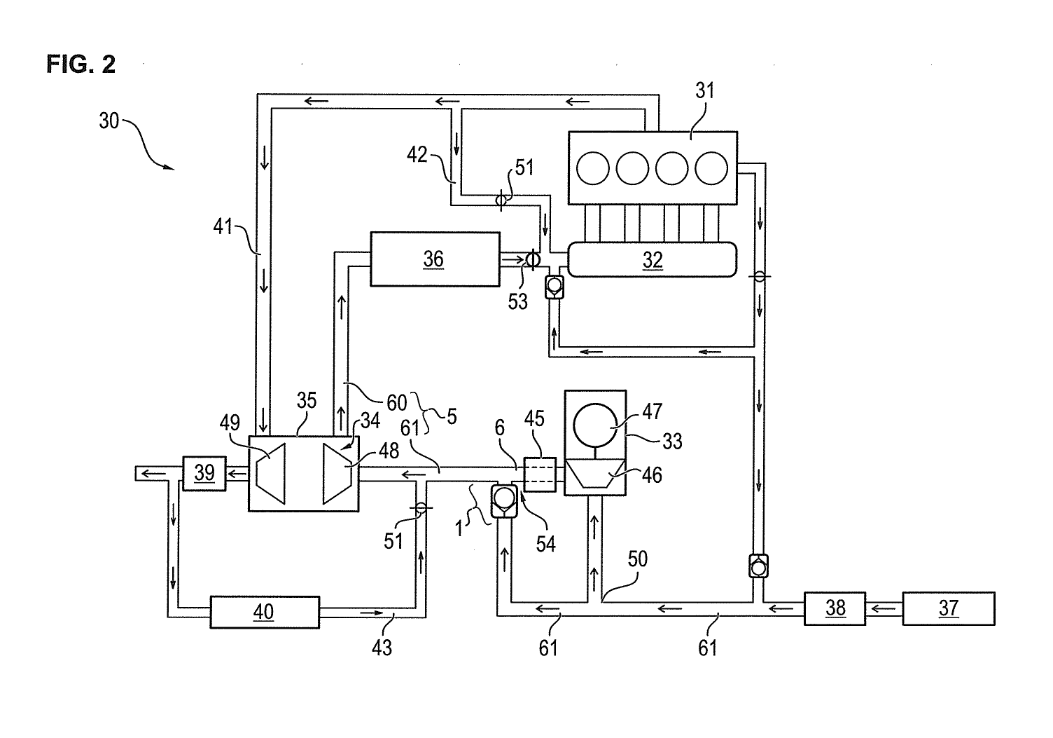

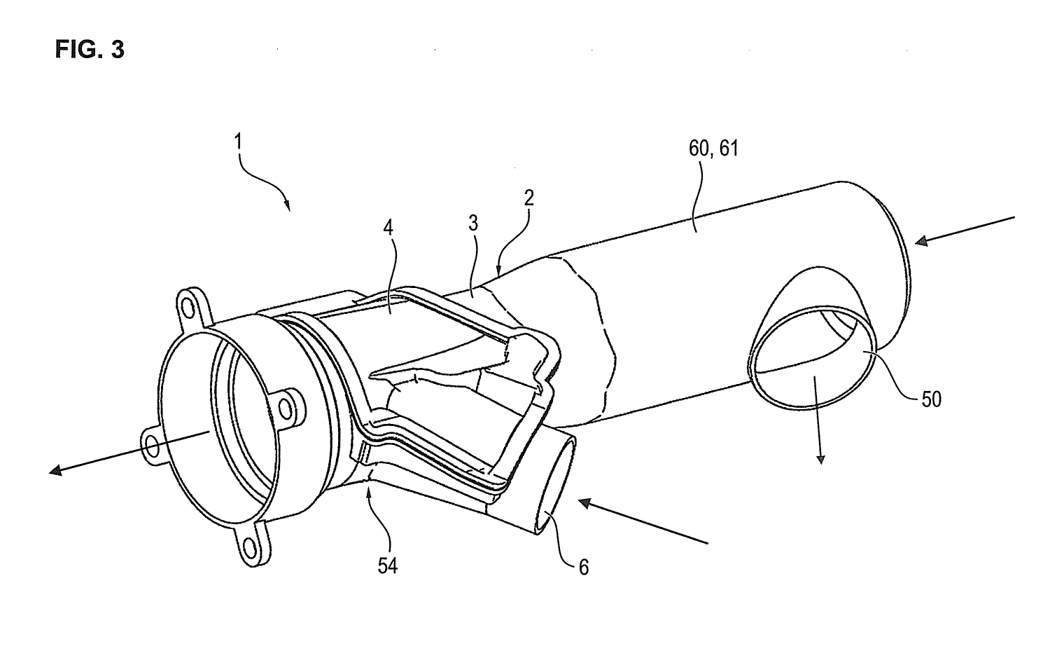

FIG. 2 shows a schematic second arrangement of the apparatus according to the invention according to the embodiment in connection to an internal combustion engine,

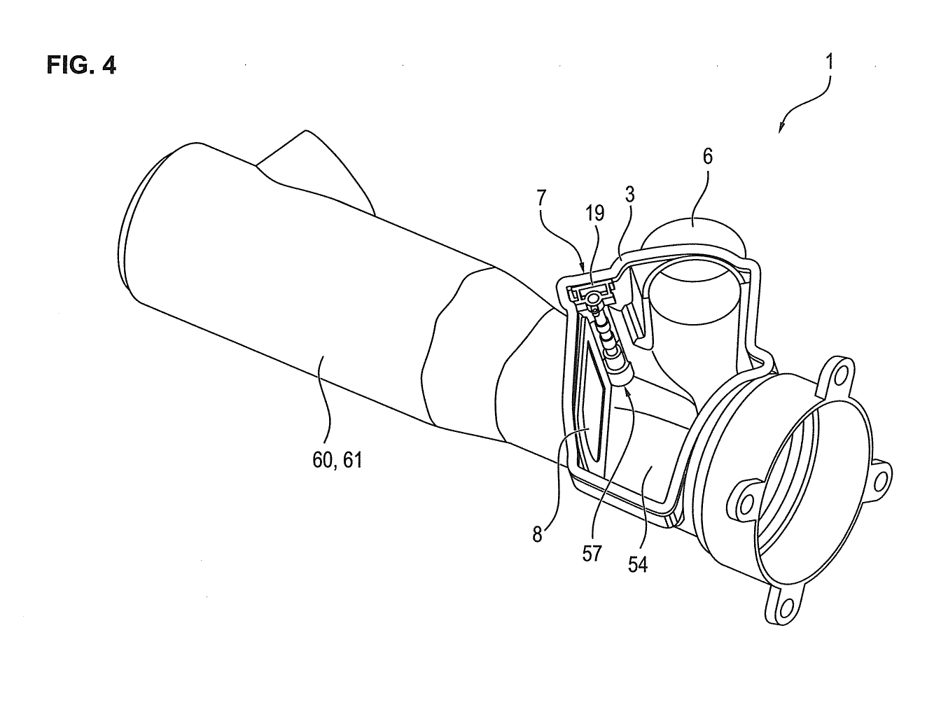

FIG. 3 shows the apparatus according to the invention according to the embodiment,

FIG. 4 shows the apparatus according to the invention according to the embodiment with the cover open,

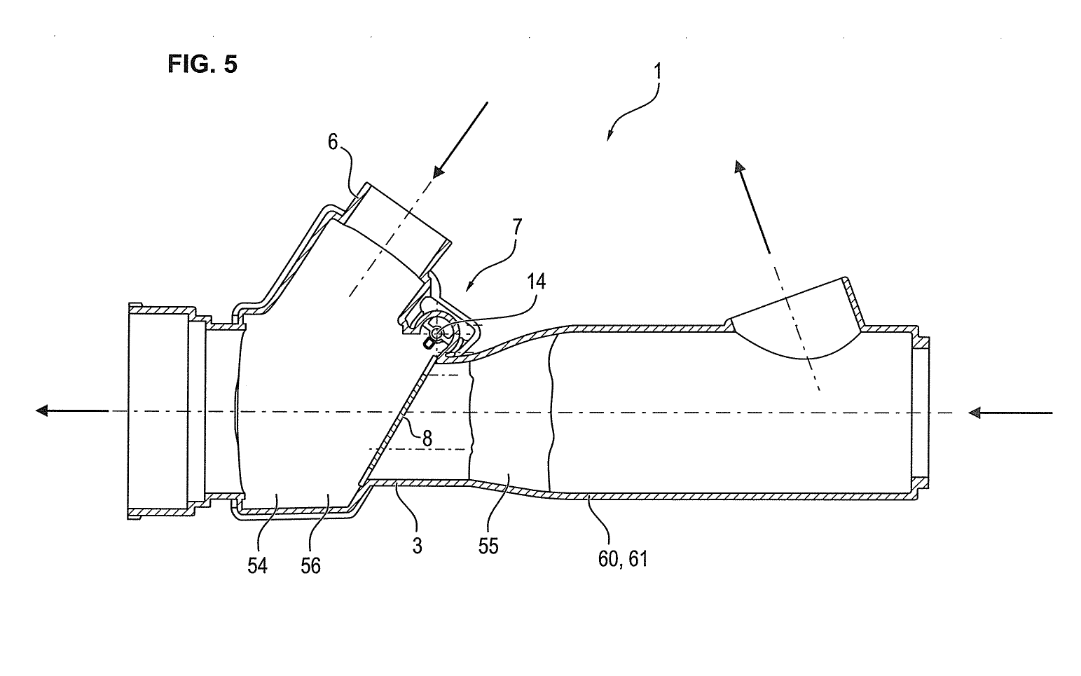

FIG. 5 shows the apparatus according to the invention according to the embodiment with the closing device closed,

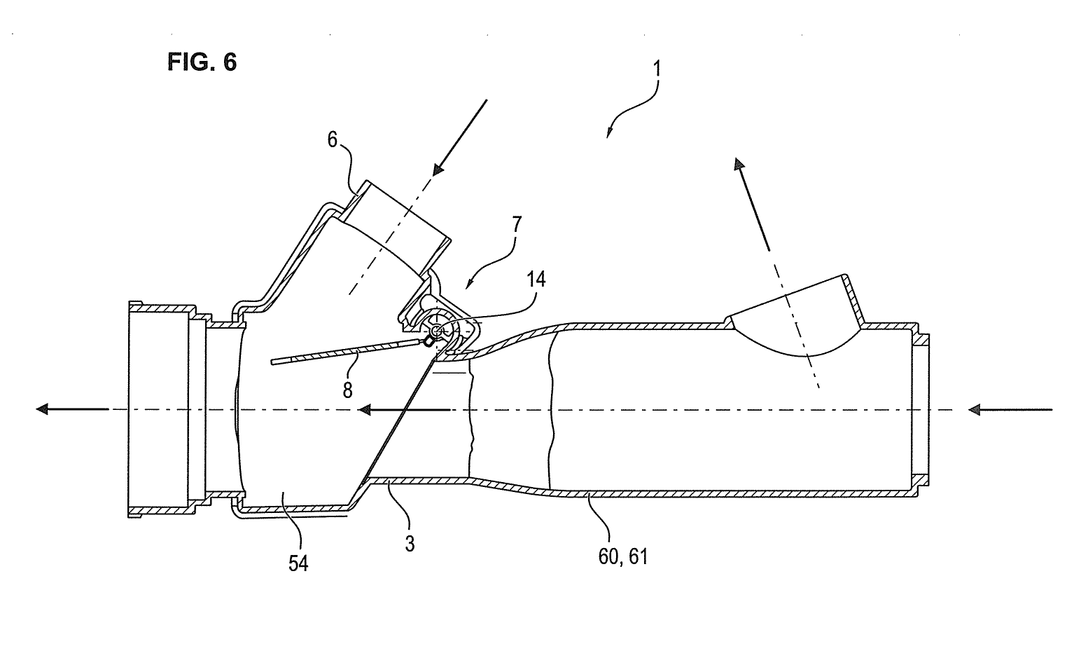

FIG. 6 shows the apparatus according to the invention according to the embodiment with the closing device open,

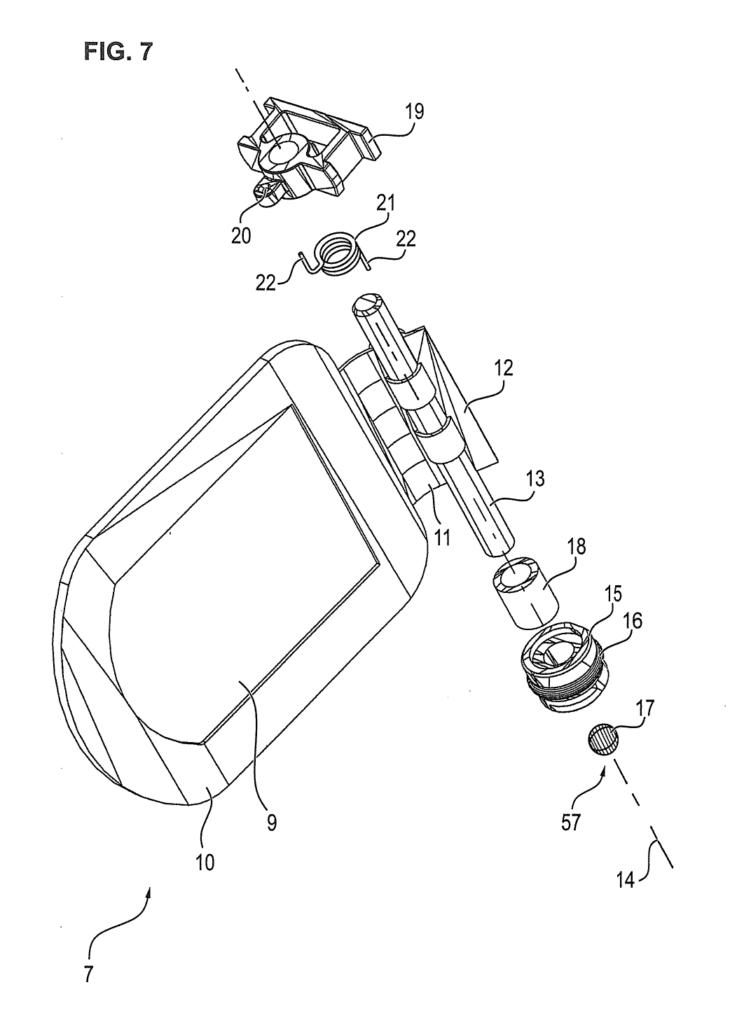

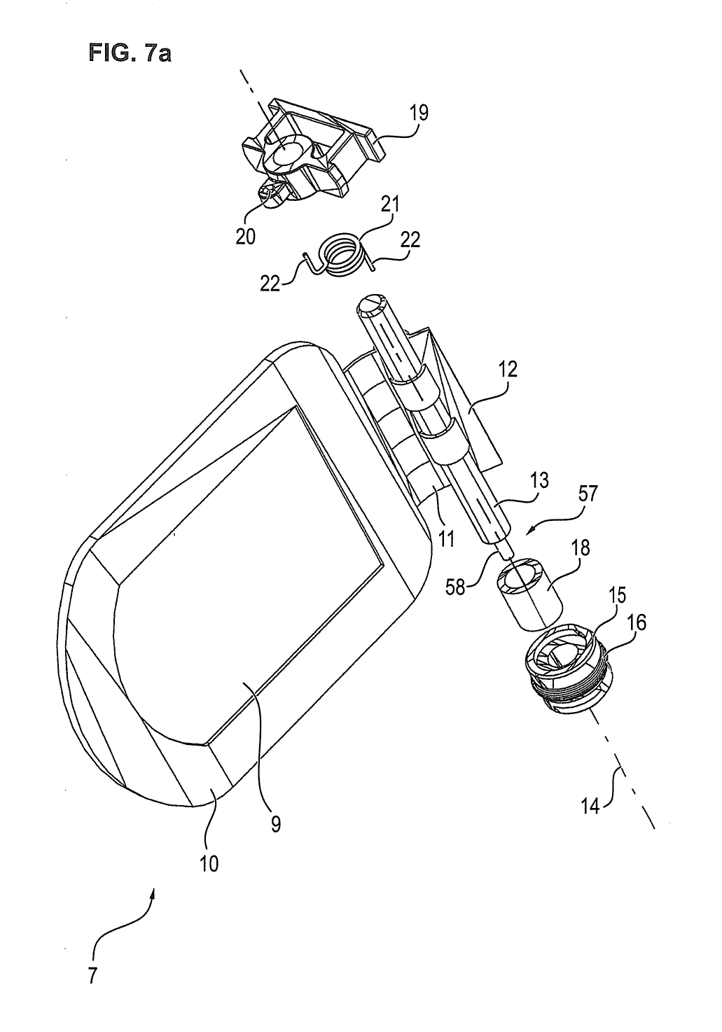

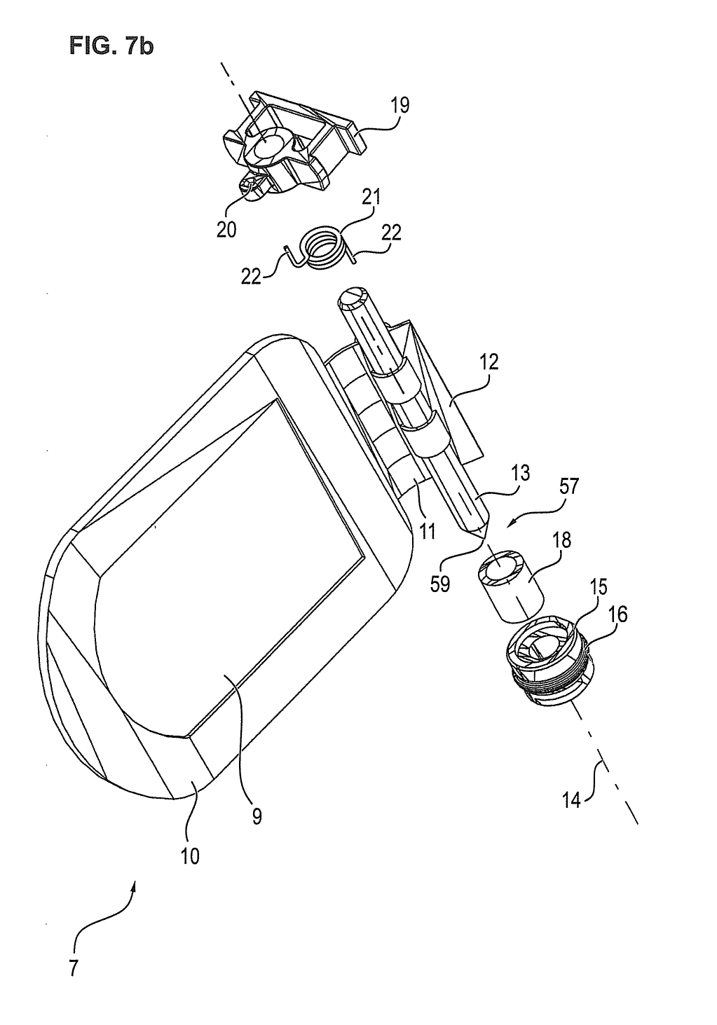

FIGS. 7, 7a, and 7b show the closing arrangement of the apparatus according to the invention according to the embodiment in an exploded view,

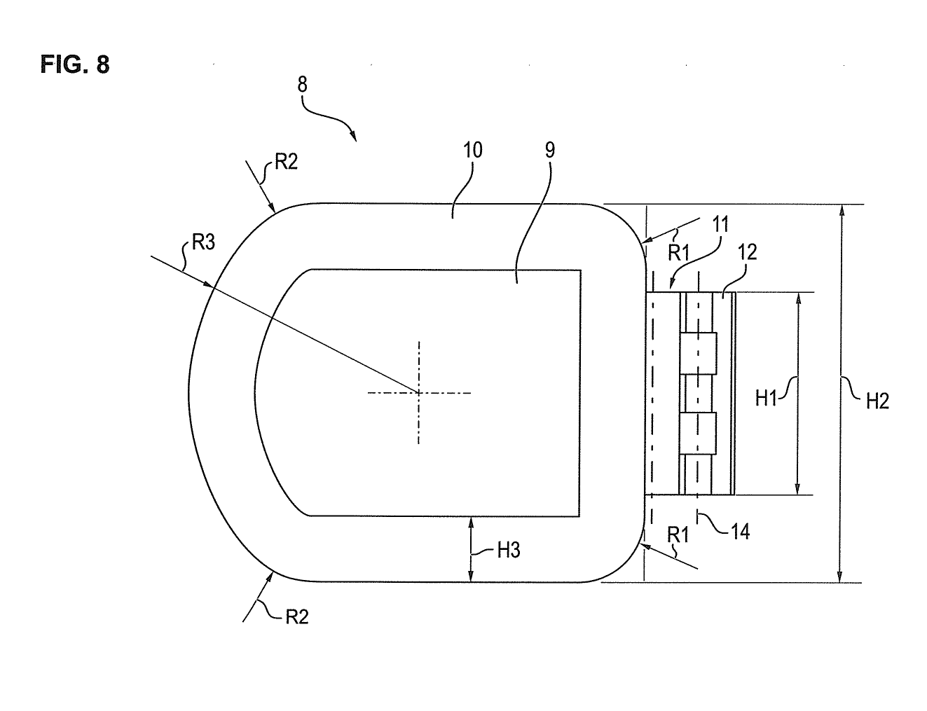

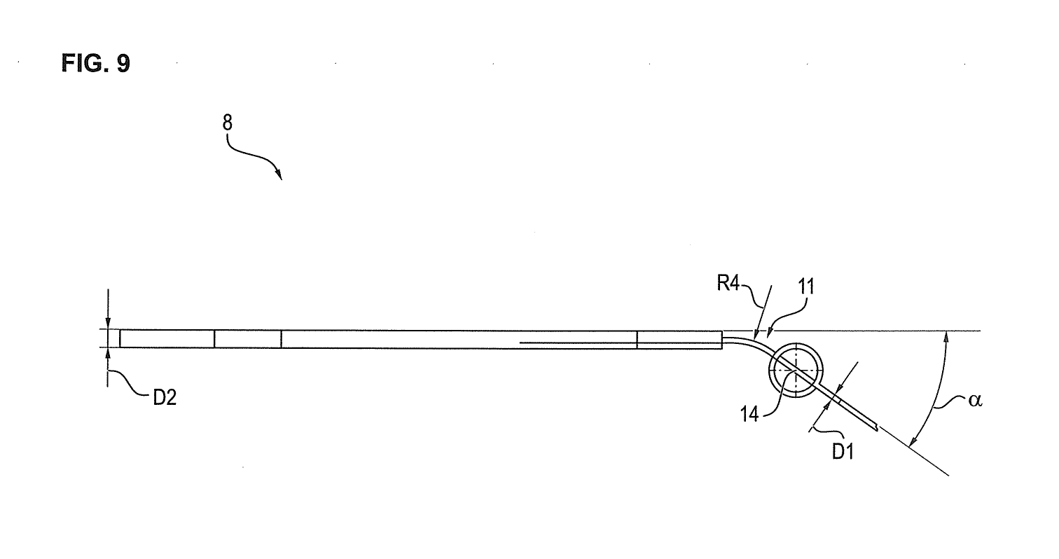

FIGS. 8, 9 show the closing device of the apparatus according to the invention according to the embodiment, and

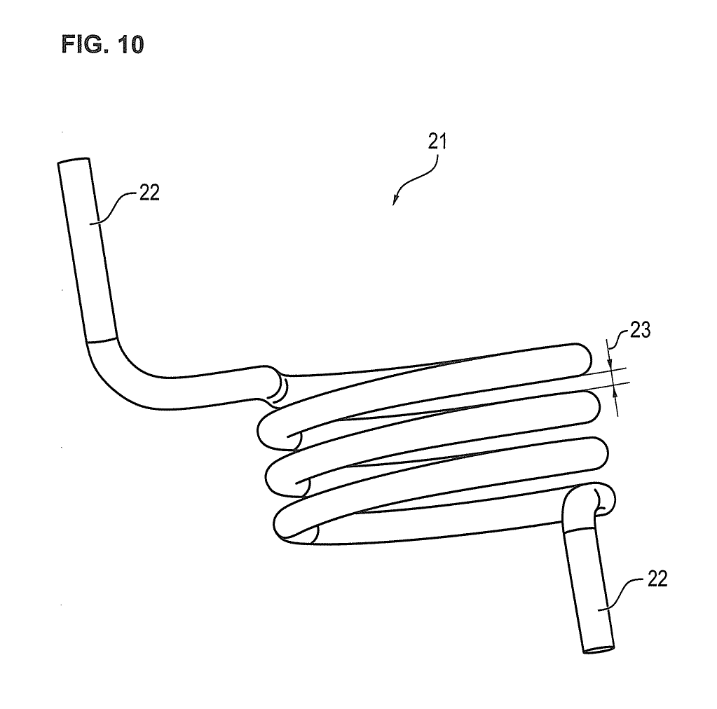

FIG. 10 shows the torsion spring of the apparatus according to the invention according to the embodiment.

In the following, two different arrangements 30 will be described by means of FIGS. 1 and 2. The apparatus 1 according to the invention is arranged at different positions in these arrangements 30.

FIG. 1 shows an internal combustion engine 31 in a motor vehicle comprising an intake manifold 32. An air duct 5 leads from an air filter 37 via an air volume measuring device 38 and a charge air cooler 36 up to intake manifold 32. A throttle 53 is arranged between charge air cooler 36 and intake manifold 32. A main compressor 34 divides air duct 5 into an intake line 61 and a main charge air duct 60.

An additional compressor 33 is connected at a branch 50 to main charge air duct 60. A secondary line 6 (pressure side of additional compressor 33) leads back into main charge air duct 60.

The apparatus 1 according to the invention is arranged at the bypass between branch 50 and an outlet 54 of secondary line 6. In the example shown, additional compressor 33 comprises an additional compressor wheel 46 which is driven via an electric motor 47.

An exhaust gas turbocharger 35 is arranged upstream of additional compressor 33. Exhaust gas turbocharger 35 comprises main compressor 34. This main compressor 34 has a main compressor wheel 48. Main compressor wheel 48 is driven via a turbine wheel 49.

Additional compressor 33 and main compressor 34 are located between charge air cooler 36 and air volume measuring device 38.

An exhaust line 41 leads from internal combustion engine 31 to turbine wheel 49 of exhaust gas turbocharger 35. From exhaust gas turbocharger 35, exhaust line 42 leads to additional exhaust gas systems via a diesel particle filter 39.

Downstream of diesel particle filter 39, a low-pressure exhaust gas recirculation 43 branches off of exhaust gas line 41. Low-pressure exhaust gas recirculation 43 leads, via exhaust gas cooler 40, into intake line 61 upstream of main compressor 34. At the opening, a controllable valve 51 is provided in low-pressure exhaust gas recirculation 43 in this case.

In addition, upstream of turbine wheel 49, a high-pressure exhaust gas recirculation 42 branches off of exhaust line 41. High-pressure exhaust gas recirculation 42 opens into main charge air duct 60 downstream of throttle 53. An additional controllable valve 51 is provided in high-pressure exhaust gas recirculation 42.

In FIG. 2, additional compressor 33 and additional compressor wheel 46 thereof, which is driven by an electric motor, are located upstream from exhaust gas turbocharger 35. Apparatus 1 according to the invention is arranged in this case in turn in a section of air duct 5 (bypass) surrounding additional compressor 33: branch 50 of additional compressor 33 is connected at intake line 61. Secondary line 6 leads from additional compressor 33 (pressure side of additional compressor 33) back into intake line 61. Otherwise, arrangement 30 according to FIG. 2 corresponds to arrangement 30 according to FIG. 1.

In FIGS. 1 and 2, acoustic dampers 45 are drawn in secondary line 6. These acoustic dampers 45 may be used at different positions and in different numbers in secondary line 6 and/or in air duct 5.

In particular, acoustic broadband dampers are provided for installation in order to damp the high-frequency components above 6 kHz.

FIG. 3 shows apparatus 1 in detail. Apparatus 1 comprises a housing 2. Housing 2 in turn is formed from a housing base body 3 and a cover 4 closing housing base body 3. Housing base body 3 and cover 4 are manufactured, in particular, from plastic material. For a sealed closure of cover 4, cover 4 is advantageously glued or welded to housing base body 3.

Housing 2 forms a section of air duct 5, in particular of main charge air duct 60 (according to FIG. 1) or of intake line 61 (according to FIG. 2). An opening 54 of secondary line 6 into air duct 5 is formed in the region of cover 4.

FIG. 4 shows apparatus 1 without cover 4. With the aid of this depiction, it may be seen that a closing arrangement 7 is provided in the region of opening 54. Closing arrangement 7 comprises a closing device 8. Closing device 8 is also designated as flap 8. According to FIG. 4, closing device 8 is closed and closes the bypass into air duct 5. Looking at the depiction in FIG. 1 or 2, it may be recognized that this section of air duct 5 is a bypass. Correspondingly, closing device 8 is also designated as bypass closing device.

FIGS. 5 and 6 show apparatus 1 in a sectional view. According to FIG. 5, closing device 8 is closed. When compressor 33 shown in FIG. 1 is active and at the same time exhaust gas turbocharger 35 generates no or only a very low pressure, the overpressure supports a spring 21 (see FIG. 7) in the sealing closing of closing device 8. This ensures that the charge air is conveyed in the correct direction, specifically to internal combustion engine 31. Closing device 8 moves depending on a spring force of spring 21 and on the pressure conditions upstream 55 and downstream 56 of closing element 8.

FIG. 6 shows a closing device 8 in the open position. When exhaust gas turbocharger 35 generates a correspondingly high pressure, closing device 8 opens.

FIG. 7 shows the exact configuration of closing arrangement 7 in an exploded view. All components shown in FIG. 7 are arranged inside of housing 2, and thus encapsulated by housing 2. None of the components protrude through housing 2 to the outside. Furthermore, there are no active actuators for moving closing arrangement 7.

According to FIG. 7, closing device 8 is arranged to be rotatable about an axis of rotation 14. A shaft 13 is used for this rotatable arrangement. Closing device 8 is connected rotatably fixed to shaft 13. Shaft 13 is in turn rotatably mounted with respect to housing 2. Closing device 8 comprises a plate 9, a seal 10, and a fastening region 11 with an overhang 12. Secondary line 6 opens into air duct 5 (main charge air duct 60 according to FIG. 1 or intake line 61 according to FIG. 2) at an acute angle. Shaft 13 is located in this acute angle, thus between secondary line 6 and air duct 5.

Plate 9, made, for example, from plastic material or metal, has seal 10 sprayed on around the entire circumference. Closing device 8 has fastening region 11 toward shaft 13. Fastening region 11 is formed, in particular, by sheet metal. On the side of shaft 13 facing away from plate 9, fastening region 11 overhangs beyond shaft 13 with overhang 12.

A first bearing component 15 is provided on the bottom side of closing arrangement 7. The bottom end of shaft 13 is rotatably mounted in this first bearing component 15.

First bearing component 15 is surrounded by an 0-ring 16 (elastic element). By this means, first bearing component 15 is elastically mounted in housing 2. A spacer sleeve 18 extends on shaft 13 between first bearing component 15 and fastening region 11.

A bottom axial stop 57 of shaft 13 contacts a sphere 17. Sphere 17 ensures a low-friction mounting of shaft 13 with respect to housing 2.

According to FIG. 7a, a pin 58 may be used on the end of shaft 13 for axial stop 57 instead of sphere 17. According to FIG. 7b, a point 59 is used at the end of shaft 13 for axial stop 57 instead of sphere 17. Pin 58 and point 59 may also be designed additionally or alternatively in housing base body 3 to form low-friction axial stop 57.

At the top side, shaft 13 is rotatably mounted in a second bearing component 19. Second bearing component 19 is pushed in a positive locking way into housing 2. Due to this positive locking with respect to housing 2, second bearing component 19 is arranged rotatably fixed with respect to axis of rotation 14. Second bearing component 19 has a shank receptacle 20 in the form of a hole.

A coiled spring 21 made from wire sits on shaft 13 between second bearing component 19 and fastening region 11.

Spring 21 is formed primarily as a torsion spring and correspondingly has two shanks 22 extending parallel to axis of rotation 14. The upper shank 22 inserts into the shank receptacle 20 of second bearing component 19. The lower shank 22 contacts on overlap 12 of closing device 8. In correspondence with other arrangements, lower shank 11 may, for example, contact on fastening region 11 between shaft 13 and plate 9. It is decisive that spring 21 is arranged in order to rotate closing device 8 in the closing direction.

In addition to its function as a torsion spring, spring 21 also functions as a compression spring in the axial direction with respect to axis of rotation 14. FIG. 10 shows spring 21 in detail. According to FIG. 10, the individual windings of spring 21 are spaced apart from one another with a clearance 23. Due to this clearance 23, spring 21 may also function as a compression spring in the axial direction.

These spring functions ensure that the closing device is held in a defined axial position. This guarantees a good axial positioning, by which means axial wobbling or oscillations are prevented. In addition, the compression spring functionality supports the sealing of closing device 8, because closing device 8 and shaft 18 are held in an axial end position by spring 21. By this means, an optimal axial position of closing device 8 is established, which consequently leads to an optimal sealing function between seal 10 and the sealing seat in housing 2.

FIGS. 8 and 9 show the exact embodiment of closing device 8 in two different views. Closing device 8 has at its periphery the radii R1, R2, and R3. These radii R1, R2, and R3 are correspondingly configured as the geometric embodiment of air duct 5 or of the sealing seat in air duct 5. Radii R1 and R2 are preferably between 5 and 20 mm. Radius R3 is advantageously between 10 and 40 mm.

Fastening region 11 has, measured parallel to axis of rotation 14, a fastening height H1. The entire closing device 8 has a closing device height H2. Fastening height H1 is advantageously at most 90%, particularly preferably at most 80% of closing device height H2. Due to this sufficiently small configuration of fastening region 11, the two bearing components 15, 19, and spring 21 have sufficient space and the total design of closing arrangement 7 is not substantially taller than closing device height H2.

FIG. 8 further shows a sealing width H3 of the seal applied on plate 9. Sealing width H3 is advantageously at least 5%, in particular at least 10%, particularly preferably at least 20% of closing device height H2 so that sufficient area is provided for the seal.

FIG. 9 shows closing device 8 in a side view. A sheet metal thickness D1 of fastening region 11 is thereby indicated. Furthermore, FIG. 9 shows a closing device thickness D2 of plate 9. The sheet metal thickness D1 is advantageously at most 70%, particularly preferably at most 60% of closing device thickness D2. In particularly, sheet metal thickness D1 lies between 0.2 and 1 mm.

Fastening region 11 is bent at an angle α with respect to plate 9. Based on the correspondingly low sheet metal thickness D1 and this bending, an elastic articulation of plate 9 results and thus a better contact in the sealing seat, as an angular offset may be compensated for. The bending is carried out advantageously with a radius R4 of 3 to 10 mm.

### LIST OF REFERENCE NUMERALS

1 Apparatus

2 Housing

3 Housing base body

4 Cover

5 Air duct

6 Secondary line

7 Closing arrangement

8 Closing device

9 Plate

10 Seal

11 Fastening region

12 Overhang

13 Shaft

14 Axis of rotation

15 First bearing component

16 O-ring

17 Sphere

18 Spacer sleeve

19 Second bearing component

20 Shank receptacle

21 Spring

22 Shank

23 Clearance

30 Arrangement

31 Internal combustion engine

32 Intake manifold

33 Additional compressor

34 Main compressor

35 Exhaust gas turbocharger

36 Charge air cooler

37 Air filter

38 Air volume measuring device

39 Particle filter

40 Exhaust gas cooler

41 Exhaust line

42 High-pressure exhaust gas recirculation

43 Low-pressure exhaust gas recirculation

45 Acoustic damper

46 Additional compressor wheel

47 Electric motor

48 Main compressor wheel

49 Turbine wheel

50 Branch

53 Throttle

54 Opening

55 Upstream

56 Downstream

57 Axial stop

58 Pin

59 Point

60 Main air duct

61 Intake line

H1 Fastening height

H2 Closing device height

H3 Seal width

R1-R4 Radii

D1 Sheet metal thickness

D2 Closing device thickness

α Angle

1. An apparatus (1) for a charging system of an internal combustion engine (31), comprising
a housing (2) in which a secondary line (6) of an additional compressor (33) opens at an opening (54) into an air duct (5) of the internal combustion engine (31),
a closing device (8) in the housing (2) for closing the air duct (5) upstream of the outlet (54), wherein the closing device (8) is arranged pivotably about a geometric axis of rotation (14), and
at least one spring (21) arranged in the housing (2), wherein the spring (21) biases the closing device (8) in the closing direction, and wherein the closing device (8) is moved exclusively by the spring force of the spring (21) and the pressure conditions upstream (55) and downstream (56) of the closing device (8).

2. The apparatus (1) according to claim 1, characterized in that the spring (21) is formed by a torsion spring surrounding the axis of rotation (14) in a spiral shape.

3. The apparatus (1) according to claim 1, characterized by a shaft (13) arranged along the axis of rotation (14) rotating with the closing device (8).

4. The apparatus (1) according to claim 3, characterized in that, at least one axial stop (57) of the shaft (13),
a sphere (17) is arranged, or
a pin (58) is designed on the housing (2) and/or on the shaft (13), and/or
a point (59) is designed on the housing (2) and/or on the shaft (13) for a low-friction mounting.

5. The apparatus (1) according to claim 3, characterized by a first bearing component (15) for rotatable support of the shaft (13), wherein an elastic element, preferably an O-ring (16) surrounding the axis of rotation (14) is arranged between the first bearing component (15) and the housing (2).

6. The apparatus (1) according to claim 3, characterized by a second bearing component (19) for rotatable support of the shaft (13), wherein the second bearing component (19) is pushed into the housing (2) rotatably fixed.

7. The apparatus (1) according to claim 3, characterized in that the closing device (8) has a plate (9) and a fastening region (11), wherein the fastening region (11) is connected to the shaft (13), and wherein the fastening region (11) is bent at an angle (α) with respect to the plate (9).

8. The apparatus (1) according to claim 1, characterized in that a seal (10) is arranged on the closing device (8) for sealing the sealing seat of the closing device (8).

9. The apparatus (1) according to claim 1, comprising the additional compressor (33), wherein the additional compressor (33) comprises an electric motor (47) for driving an additional compressor wheel (46).

10. The apparatus (1) according to claim 9, comprising a main compressor (34), preferably in an exhaust gas turbocharger (35), the main compressor wheel (48) thereof compresses the air in the air duct (5) upstream or downstream of the closing device (8).

11. The apparatus (1) according to claim 1, characterized in that
at least one acoustic damper (45) is arranged in the secondary line (6) upstream of the additional compressor (33), and/or
at least one acoustic damper (45) is arranged in the secondary line (6) downstream of the additional compressor (33), and/or
at least one acoustic damper (45) is arranged in the air duct (5) upstream of the main compressor (34), and/or
at least one acoustic damper (45) is arranged in the air duct (5) downstream of the main compressor (34).
